(19) United States
(12) Patent Application Publication
(10) Pub. No.: US 2013/0122166 A1
(43) Pub. Date: May 16, 2013

(54) Automated multy layered parotta production process

(71) Applicant: ELIL ARASAN DHANDAPANI, Eumemmerring (AU)

(72) Inventor: ELIL ARASAN DHANDAPANI, Eumemmerring (AU)

(21) Appl. No.: 13/401,855

(22) Filed: Feb. 22, 2012

(30) Foreign Application Priority Data
Aug. 19, 2011 (AU) 2011101066

(51) Int. Cl. A21D 8/02

(52) U.S. Cl. CPC A21D 8/02
USPC 426/393

(57) ABSTRACT

This invention Automated multi layered Poratta production process is fully hygienic and automatic production system. In Asian countries multi layered Parotta/flat bread production is done by hand and its hard labour-ship. In this above mentioned process very thin 0.5 mm wheat flour dough is done by sheeter machine. This thin sheet is rolled and kept in freezer below −18 degree centigrade. After this rolled dough got rigid, its sliced and cooked by hot plate press cooking. This will deliver multi layered Parotta after cooking. This product is cooled below 20 degree centigrade with the help of the cooling system. After cooling the product is immediately packed.

### FIELD OF THE INVENTION

This invention relates to a food product produced according to a particular process and to the process for production of that food product. The present invention further relates to the production of parotta fiat bread and the process of automated lines as described below. The parotta flat bread is a common part of the diet of the people in south India.

The automated multi layered parotta production process is comprised with two stages. First stage is to comprise the normal standard mixer, thin dough sheeter with flour duster for a non sticky layer and frozen room for rolled dough freeze.

Second stage is a comprise of the frozen dough slicer on to a temperature zone travelling metal wired knitted conveyer for thawing and proving the sliced dough. A photo sensor oiling spray station is providing a thin layer oil coating to the sliced dough prior to hotplate pressing and cooking. A hot plate pressing and cooking station having two hotplates top & bottom, both side thermal heat providing a desirable cooking and shape to the parotta. A cooling zone travelling conveyer allows the cooked parotta to he cooled to the desired ambient temperature prior to packing.

This invention relates to an automatic multi layered parotta bread production process.

### Introduction of Parotta

Below passage details are taken from www.wikipedia for brief details about Parotta. A Parotta or Barotta, is a common layered flat bread of Southern India. This is not to be confused with the North Indian Paratha. Parottas are usually available in restaurants and road side shops across Kerala, Karnataka, Tamil Nadu and the Middle East (introduced by the South Indians). It is also served in marriage and religious festival and feasts. It is prepared with Maida (Wheatflour) and Oil/Ghee by beating the mixture into thin layers and later forming round bread with the thin layers.

Usually, parottas are relished with vegetable kuruma and onion rings (in case of Veg restaurants) and chicken, mutton or beef saalna (a spicy sauce in non-vegetarian restaurants). Other variants of the common parottas are Kerala parotta, Chilli parotta, Coin parotta, Veechu parotta and Kothu parotta.

Parottas are more popular in the southern part of India. The most relishing parottas are the one that are deep fried. They are very famous in the southern part of Tamil Nadu, especially in Tuticorin, Viruthunagar and Madurai where they served it traditionally in a leaf.

Parottas go well with the normal gravy known as Salna. Chicken dishes and egg dishes are most preferred with parottas.

### OBJECT OF THE INVENTION

The hand made parotta production process is intensive and consists of hard manual labour as well as consuming lot of time. And also the way of making hand made parotta is not complying with food hygiene. In order to produce parotta bread commercially as per “Food Standard Australia New Zealand” standards, a high degree of automation is required, which leads to the following submission for an automatic multi layered parotta bread production process.

### OUTLINE OF THE INVENTION

According to the present invention provided there does an automated multi layered parotta bread production process comprise as 2 stages.

First stage comprises a mixer, thin dough sheeter and freezer.

Second stage comprises frozen dough slicer, temperature zone travelling metal wired weaved conveyer, a photo sensor oiling spray station, a hot plate pressing and cooking station, a cooling zone travelling conveyer and packaging zone.

A specific embodiment of the invention will now be described by way of example with reference to the accompanying flow chart in which:

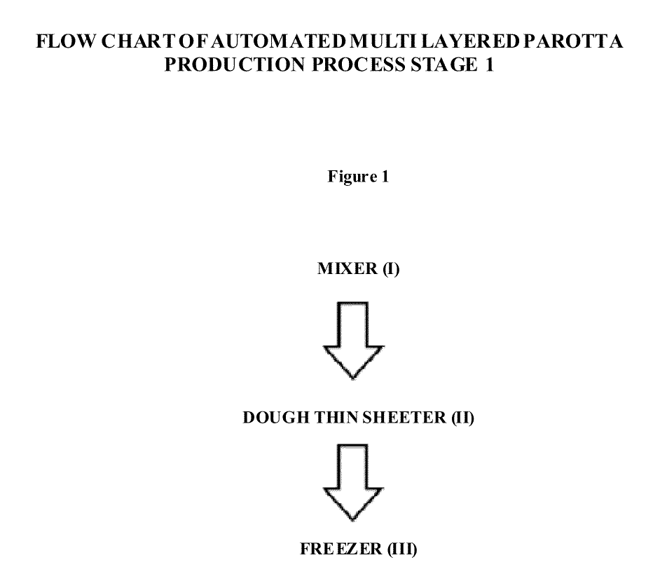

FIG. 1. Shows the automated multi layered parotta bread production process stage 1 Referring to the flow chart the automatic process comprises a mixer (I), thin dough sheeter (II) and freezer (III). Mixer assists to make a wheat flour/maida dough.

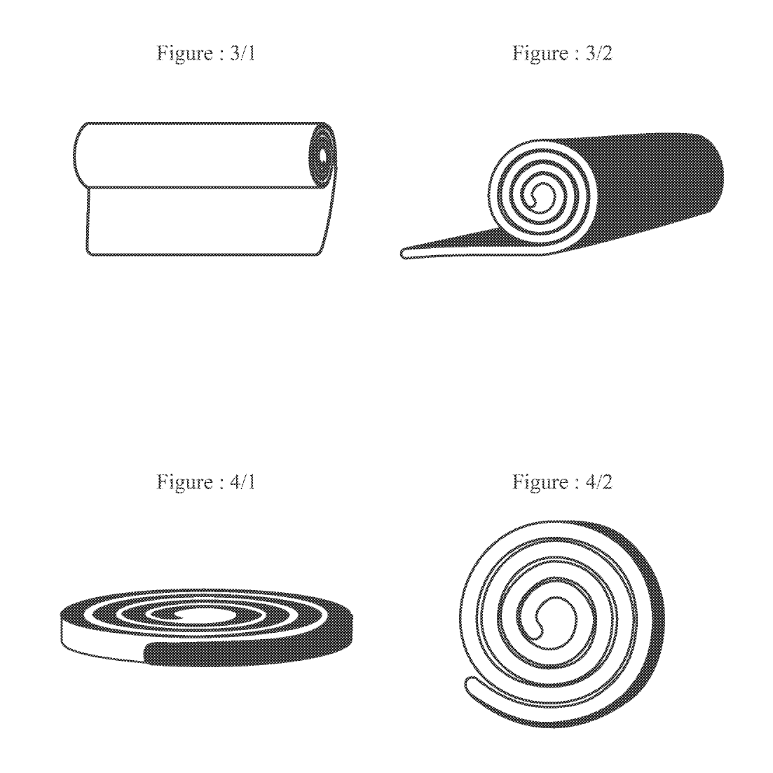

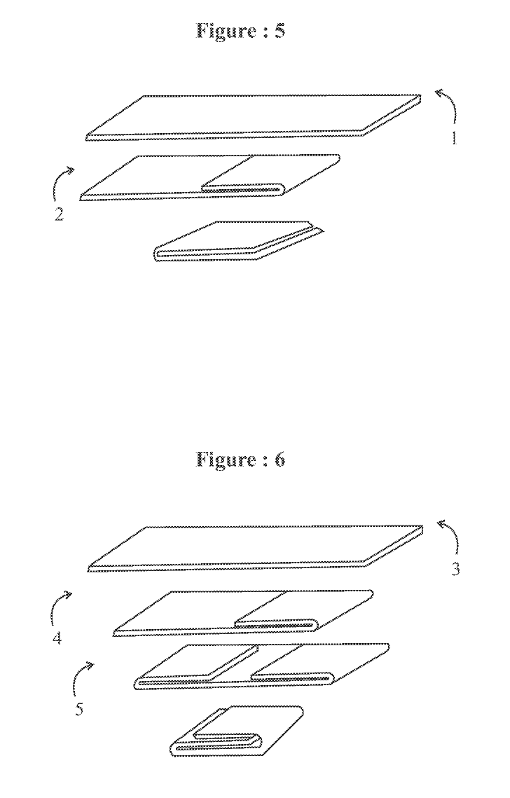

Dough sheeter assists to make a round thin dough sheet layered roll (FIG. 3/1, 3/2) dough sheeter to comprise with flour duster for conforming layered round roll dough. Dough sheet thickness minimum 0.4 mm to 10 mm and above will be achievable. Sheet folding we can make as per baking sheet norms single fold (FIG. 5), double fold or book fold (FIG. 6) or all of them can do for make dough roll. FIG. 5—1,2 FIG. 6—1,2,3 arrows are showing dough sheet folding directions. Freezer assists to make a round layered dough roll stick.

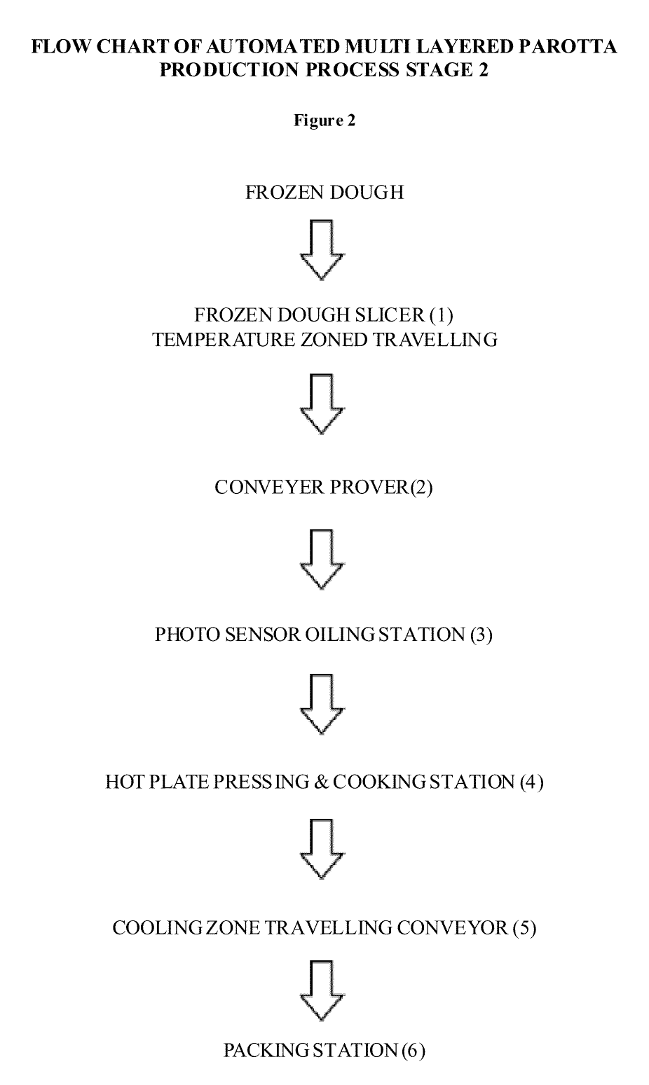

FIG. 2 Shows the automated multi layered parotta bread production processes stage 2 Referring to the flow chart the automatic process comprises a dough slicer (1) it will slice/precut (FIG. 4/1, 4/2) the frozen layered dough to the desired thickness from 1 mm to 30 mm and further we can increase up to 300 mm thickness. Temperature zone travelling metal wired weaved conveyer (2) for thawing and proving the sliced/pre cut dough. Photo sensor oiling spray station (3) is providing thin layer oil fog coating to all around the sliced/pre cut dough.

Then hot plate pressing and cooking station (4) are having dual side metal plates & thermal heat providing a desirable cooking temperature and shape, thickness to the parotta. Then while pressing the dough, same time stretching also executing in this process.

By this way of cooking we can cook and pre cook it means we can pass the temperature to the dough up to 73 degrees so we can deactivate enzymes, protean/gluten coagulation for refrigeration. Whenever we need fully cooked parotta we will reheat in cooking pans or a microwave oven above 100 degree so we will get freshly cooked parotta. A cooling zone travelling conveyer (5) allows the cooked parotta to be cooled to the desired ambient temperature as per food cooling law prior to packaging. Packing (6) zone provide hygiene packing to the multi layered parotta.

### EXAMPLE 1

PLAIN PAROTTA MIX

| INGREDIENTS | % | GRAMS |
|---|---|---|
| PLAIN FLOUR | 100 | 1000 |
| (WHEAT) | | |
| YEAST (OPTIONAL) | 2 | 20 |
| EGG (OPTIONAL) | 1 | 10 |
| FAT | 3 | 30 |
| SUGAR | 1 | 10 |
| SALT | 1.5 | 15 |
| BREAD IMPROVER | 1 | 10 |
| WATER | 60-64 | 600-640 |

### EXAMPLE 2

SWEET PAROTTA MIX

| INGREDIENTS | % | GRAMS |
|---|---|---|
| PLAIN FLOUR | 100 | 1000 |
| (WHEAT) | | |
| YEAST (OPTIONAL) | 2 | 20 |
| EGG (OPTIONAL) | 1 | 10 |
| FAT | 3 | 30 |
| SUGAR | 25 | 250 |
| SALT | 1.5 | 15 |
| BREAD IMPROVER | 1 | 10 |
| WATER | 58-61 | 580-610 |

1. The improved automated multi layered parotta bread production process consisting of treating wheat flour through various equipments as detailed in stage 1 and 2;
Stage 1 comprises equipments including spiral mixer, pastry dough sheeter, flour duster and a freezer;
Stage 2 comprises equipments including frozen dough vertical slicing machine, long defrost conveyor retard prover, oil spray station, and dual side hot plate cooking, pressing station, a cooling and packing station.

2. The improved automated multi layered parotta bread production process as claimed in claim 1 where in stage 1 comprises;
spiral mixer which assists in mixing wheat flour so as to produce a bulk size wheat flour dough; pastry sheeter which assists in making a very thin and flexible dough sheet in the size of 0.4 mm to 1 mm thickness, 24 inch width, length according to 4 to 9 inch diameter roll from said wheat flour dough;
flour duster which assists in layer formation by spreading wheat flour dust, between the layers while making said in flexible dough film and freezer which assists in strengthening and imparting rigidity to the said multi layered dough film.

3. The improved automated multi layered parotta bread production process as claimed in claim 1 where in stage 2 comprises;
frozen dough vertical slicing machine which assists in slicing/pre-cutting said frozen multi-layer dough of obtain from stage one to a thickness 1 cm to 10 cm and weight as decided; long defrost conveyer retard prover which assists in defrosted/thawing said sliced dough using horizontal metal wired continuous moving mechanism with overhead heaters;
oil spray station which assists in coating said sliced defrosted dough with a light oil fog using the oil nozzle so as to prevent dough sticking from one roll to another;
dual side hot plate cooking and pressing station which assists in pressing and heating the said sliced multi layered oil coated dough and comprise a temperature controlled heating facility for cooking said sliced layered oil coating dough;
the temperature control heating facility contain 2 stainless steel plates of 1 inch thickness 24 inch width and 24 inch length positioned at interchangeable 26.6 degree angle, plate sizes are interchangeable according to desired product, the bottom steel plate is fixed while top plate is adjustable for time control upward and downward movement with hydraulic, pneumatic power operated system who pressing pressure is interchangeable to according to the desired product and results in a flat spiral layer shaped parotta.

4. The improved automated multi layered parotta bread production process as claimed in claim 3 where in stage 2 further comprises a cooling and packing station which comprises in a moving apparatus that assisting in cooling the finished parotta product obtain according to claim 3 to the desired cooling temperature of 21 degree Celsius within 2 hour after cooking followed by packing and storing below 5 degree Celsius within about 2 hour time.

5. The improved automated multi layered parotta bread production process according to claim 1 substantially as herein before described with reference to FIGS. 1-6 of the accompanying drawings.
